(19) United States
(12) Patent Application Publication
(10) Pub. No.: US 2007/0003652 A1
(43) Pub. Date: Jan. 4, 2007

(54) Apparatus and process for producing and delivering a foamable plastic

(75) Inventor: Andreas Beckmann, Bielefeld (DE)

Correspondence Address: LERNER GREENBERG STEMER LLP, P O BOX 2480, HOLLYWOOD, FL, 33022-2480, US

(73) Assignee: MollerTech GmbH

(21) Appl. No.: 11/504,988

(22) Filed: Aug. 16, 2006

Related U.S. Application Data
(63) Continuation of application No. PCT/DE05/00265, filed on Feb. 16, 2005.

(30) Foreign Application Priority Data
Feb. 16, 2004 (DE) 10 2004 007 362.7

(51) Int. Cl. B29C 47/96

(52) U.S. Cl. 425/145

(57) ABSTRACT

An apparatus and a process for producing and delivering a foamable plastic, especially for injecting a foamable plastic, containing a physical blowing agent, include a casing having an interior and a screw disposed in the interior for conveying a stream of a plastics melt through at least one subsection of the interior along a conveying zone to a closable orifice of the casing. A channel in the screw has a channel exit orifice for supplying the physical blowing agent in a region of the conveying zone, so that the physical blowing agent can be added to the plastics melt. A control unit for controlling the exiting of the physical blowing agent from the channel is disposed at the screw, outside the channel and in front of the channel exit orifice.

### CROSS-REFERENCE TO RELATED APPLICATIONS

This is a continuing application, under 35 U.S.C. §120, of copending International Application No. PCT/DE2005/000265, filed Feb. 16, 2005, which designated the United States; this application also claims the priority, under 35 U.S.C. §119, of German Patent Application DE 10 2004 007 362.7, filed Feb. 16, 2004; the prior applications are herewith incorporated by reference in their entirety.

### BACKGROUND OF THE INVENTION

### Field of the Invention

The invention relates to an apparatus and a process for producing and delivering a foamable plastic with a physical blowing or foaming agent or propellant.

In such processes, a physical blowing agent is added to a plastics melt and mixed with it. That forms a foamable plastic which can be introduced into a mold, for example through the use of injection, and subsequently foamed. In a known process, the production of the foamable plastic is performed in a screw cylinder in which a plastics melt is mixed with the physical blowing agent, with the aid of a screw that is also known as a plasticizing screw. Processes are known in which the physical blowing agent is supplied through one or more orifices in the screw cylinder or an axial bore in the screw.

The disadvantage of a supply of blowing agent through one or more gas nozzles which are set into the screw cylinder is that no standard screw cylinders and no standard screw can be used for such processes. In most cases, a longer structure (greater length/diameter ratio) of the injection unit composed of the screw cylinder and the screw is necessary in order to mix the physical blowing agent with the plastics melt or to bring it into solution. That is in particular because the physical blowing agent is added in a stationary manner with the aid of one or more gas nozzles in the screw cylinder, and the screw must then possess a minimum length beyond the point of blowing agent supply, based on the flow direction in the conveying operation of the melt, so that sufficient time is available for the mixing operation of the blowing agent and the melt.

Systems which manage with the commercial screw lengths are also known from the prior art. In spite of that, the systems are still special constructions, since the screw, after the feed of blowing agent into the screw cylinder, must have special mixing elements in order to dissolve the blowing agent in the plastics melt within a short time. Moreover, the screw cylinder must still have at least one orifice for addition of the physical blowing agent. German Translated, European Patent DE 697 17 465 T2, corresponding to Published Canadian Patent Application 22 64 159 A1 and Published Australian Patent Application 755 441 B, may be mentioned as an example thereof.

Physical foaming processes in which the blowing agent is added through an axial bore in the screw are likewise described in the prior art. In that case, the screw is typically not bored through completely, but rather only from the drive side, i.e. the side of material supply, up to just before the opposite end. The blowing agent can pass into the screw cylinder through one or more bores running transverse to the central bore. Such an embodiment is described in U.S. Patent Application Publication No. US 2003/044480 A1.

Apparatuses with transverse bores in which one or more sintered metal inserts are set into the transverse bores, are also known. In a further construction, instead of one or more sintered metal inserts, a circular sintered metal insert is used, which ensures blowing agent supply into the screw cylinder from the axial bore in the screw. The sintered metal inserts prevent the penetration of plastics melt into the blowing agent feed. In that construction, a multipart structure of the screw is again necessary, in order to be able to insert the circular sintered metal insert. Such an embodiment can be learned from German Patent DE 199 34 693 C2.

In contrast to apparatuses with blowing agent supply through gas nozzles which are set into the screw cylinder, apparatuses which are based on the supply of physical blowing agents through the use of a central bore in the screw have the advantage that the technical and financial demands for the production of such a process unit are distinctly smaller. Moreover, in most cases, no excessive special lengths of the injection unit are necessary, since the blowing agent is not supplied in a stationary manner. The time required to mix the blowing agent into the plastics melt is distinctly shorter in that case, since polymer melt and blowing agent are in motion as a result of the rotation and/or the conveying action of the screw.

In order to ensure that the blowing agent which has been introduced through the bore in the screw and is still undissolved cannot escape in the direction of the material feed of the injection unit in the event that the screw stops, for example when the metering time of the screw is shorter than the sum of the cooling time of the component produced by that process and the opening and closing operations of the mold halves, U.S. Pat. No. 6,652,254 proposes providing the central bore for the blowing agent supply with a non-return valve, which should be disposed as close as possible to the exit orifice of the channel for the supply of the physical blowing agent into the melt-filled screw cylinder. It is evident from U.S. Pat. No. 6,652,254 that the non-return valve is disposed in the region of the axial bore.

In the case of apparatuses without the use of a non-return valve in the central bore of the screw, the requirement thus arises that the pressure with which the physical blowing agent is introduced into the plastics melt must always be higher than the melt pressure existing in the screw cylinder, in order to prevent penetration of melt into the channel for the supply of the blowing agent. If that should nevertheless occur, it is problematic to force it out of the blowing agent channel again through the use of further blowing agent, especially in the case of a material change from one material with a relatively high melt temperature to another material with a relatively low melt temperature.

In order to prevent reflux of the melt in the course of the injection operation in the direction of the material feed, reflux barriers are employed in order to prevent the plastics melt from being driven back in the direction of the feed of the plastic when the screw stops. Applications are also known, especially in conjunction with foaming processes, in which more than one reflux barrier is used.

### SUMMARY OF THE INVENTION

It is accordingly an object of the invention to provide an improved apparatus and an improved process for producing and delivering a foamable plastic with a physical blowing agent, which overcome the hereinafore-mentioned disadvantages of the heretofore-known apparatuses and processes of this general type and in which, with the aid of alterations requiring minimal construction, preferably with the use of standard components, provide a control of the addition of the physical blowing agent to the plastics melt.

With the foregoing and other objects in view there is provided, in accordance with the invention, an apparatus for producing and delivering a foamable plastic containing a physical blowing agent, in particular for injecting a foamable plastic. The apparatus comprises a casing having a closable orifice and an interior with at least one subsection and a conveying zone. A screw is disposed in the interior for conveying a stream of a plastics melt through the at least one subsection along the conveying zone to the closable orifice. The screw has a channel with a channel exit orifice in a vicinity of the conveying zone for supplying the physical blowing agent to be added to the plastics melt. A control unit is disposed at the screw outside the channel in front of the channel exit orifice, for controlling exiting of the physical blowing agent from the channel.

In comparison to known apparatuses, the control unit is not disposed within the channel for the supply of the physical blowing agent, but rather outside this channel. Thus, the channel can have an unchanged constructed in an optimized manner, for example with regard to favorable pressure and/or flow conditions for the blowing agent. In spite of this, with the aid of the control unit, regulation of the exit of the physical blowing agent from the channel is provided. The control unit is disposed outside the channel on or at the screw and thus does not have a disruptive effect on an optimized structure of the channel. The structural complexity and the associated costs are distinctly less.

The placement of the control unit outside the channel also has the advantage that the maintenance and the exchange of the control unit, in comparison to a configuration in the channel, can be performed with a lower level of complexity. Furthermore, a miniaturized structure of the control unit is not necessary, which is a customary requirement in the case of implementation of the control unit in the channel, especially at small screw diameters.

In accordance with another feature of the invention, a section of the conveying zone of the plastics melt is conducted through the control unit. As a result of this, the plastics melt does not have to be conducted past the control unit.

In accordance with a further feature of the invention, the control unit is constructed as a flow control unit for controlling the flow of the plastics melt along the conveying zone. In this way, the control unit fulfills both the function of controlling the exit of the physical blowing agent through the channel exit orifice and of controlling the stream of the plastics melt in the course of conveying with the aid of the screw in the plasticizing of the plastic.

In accordance with an added feature of the invention, the flow control unit is a ball reflux barrier with a ball component which is disposed so as to be mobile within a chamber, in order to control the exit of the physical blowing agent from the channel and the stream of the plastics melt. This enables control both of the exit of the physical blowing agent and of the stream of the plastics melt with the aid of a ball reflux barrier which is known as such.

In accordance with an additional feature of the invention, a limiting device for limiting the movement of the ball component within the chamber is provided in the ball reflux barrier, in order to prevent blockage of an exit section for the plastics melt by the ball component. In this way, the ball component of the reflux barrier is prevented from hindering the conveyance of the plastics melt toward the closable orifice of the casing.

In accordance with yet another feature of the invention, the channel exit orifice is formed on an end side of the screw.

Sufficient space is available in the region of the end side of the screw to be able to accommodate the control unit. Moreover, very central introduction of the physical blowing agent in the plastics melt is supported with the aid of this configuration of the channel exit orifice.

In accordance with yet a further feature of the invention, in order to improve the mixing of the plastics melt with the physical blowing agent, one embodiment of the invention envisages a mixing element disposed downstream of the control unit in conveying direction of the plastics melt in the interior, for mixing plastics melt and physical blowing agent.

In accordance with yet an added feature of the invention, in order to prevent faults in the plasticization of the plastic, a protective device is provided at the channel exit orifice to block entry of the plastics melt through the channel exit orifice into the channel. This prevents plastics melt from being able to penetrate into the channel, so that it becomes blocked, which then hinders the supply of the physical blowing agent.

In accordance with yet an additional feature of the invention, a cover for the channel exit orifice is formed with the aid of the protective device from a material having pores which are permeable to the physical blowing agent but block the entry of the plastics melt through the channel exit orifice into the channel. The material being used may, for example, be a sintered metal, for which materials with different pore sizes can be selected.

In accordance with still another feature of the invention, supplementally or alternatively to the cover, the protective device may include a spring-controlled valve which can be opened by a pressure built up by the physical blowing agent in the channel to release the physical blowing agent through the channel exit orifice against a spring force. In this way, automatic opening/closing of the channel exit orifice is enabled.

With the objects of the invention in view, there is also provided a process for producing and delivering a foamable plastic containing a physical blowing agent, in particular for injecting a foamable plastic. The process comprises providing an apparatus including a casing having a closable orifice and an interior with at least one subsection, a conveying zone and a screw. A stream of a plastics melt is conveyed through the at least one subsection along the conveying zone toward the closable orifice. The physical blowing agent is added to the plastics melt by feeding the physical blowing agent to a region of the conveying zone through a channel formed in the screw and an exit orifice of the channel. The plastics melt and the physical blowing agent are mixed along the conveying zone. The plastics melt mixed with the physical blowing agent is delivered through the closable orifice of the casing. Exiting of the physical blowing agent from the channel through the channel exit orifice is controlled with a control unit disposed at the screw, outside the channel and in front of the channel exit orifice. Other developments of the process have the advantages mentioned in connection with the apparatus in a corresponding manner.

Other features which are considered as characteristic for the invention are set forth in the appended claims.

Although the invention is illustrated and described herein as embodied in an apparatus and a process for producing and delivering a foamable plastic, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, longitudinal-sectional view of an apparatus for plasticizing a plastic with a physical blowing agent before an injection operation;

FIG. 2 is a view similar to FIG. 1 of the apparatus for plasticizing a plastic with a physical blowing agent, during an injection operation;

FIG. 3 is a fragmentary, longitudinal-sectional view of a further apparatus for plasticizing a plastic with a physical blowing agent, with the provision of a mixing element;

FIG. 4 is a fragmentary, longitudinal-sectional view of another apparatus for plasticizing a plastic with a physical blowing agent, similar to the apparatus of FIG. 1, except that a sintered metal is disposed in the region of an exit orifice;

FIG. 5 is a fragmentary, longitudinal-sectional view of a section of a channel for supplying a physical blowing agent, with a spring-controlled valve; and

FIG. 6 is a view similar to FIG. 5 of the section of the channel with a modified spring-controlled valve.

### DESCRIPTION OF THE PREFERRED EMBODIMENTS

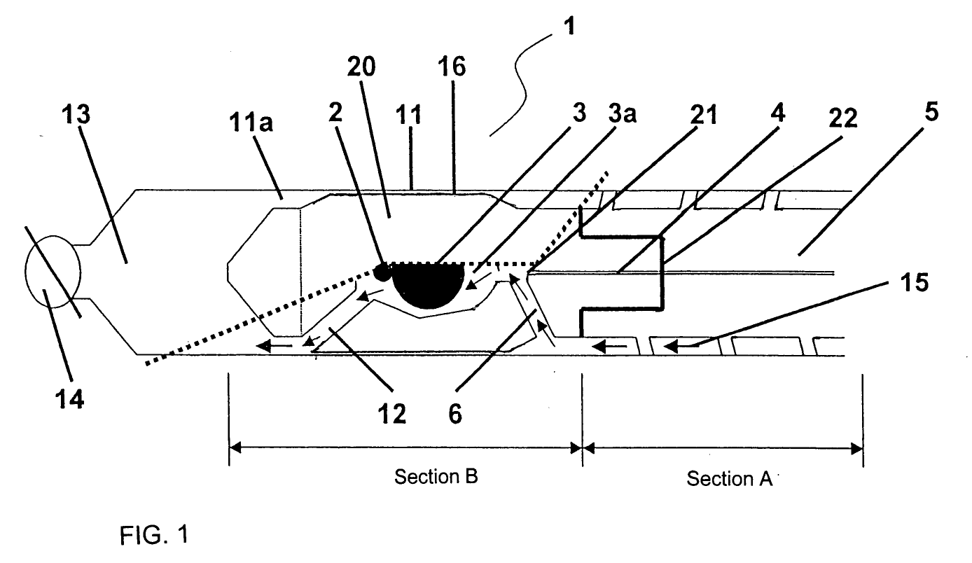

Referring now to the figures of the drawings in detail and first, particularly, to FIG. 1 thereof, there is seen an apparatus for plasticizing a plastic with a physical blowing or foaming agent or propellant. A plasticizing unit 1 includes a plasticizing section, shown as section A, a screw 5 which has a central screw bore or channel 4, and a cylinder wall 11 which surrounds an interior 11a in which the screw 5 is disposed so as to be rotatable. In order to simplify the illustration, a material feed for the plasticizing unit 1 and a drive unit for the rotating drive of the screw 5 are not shown in FIG. 1. A plastics melt is conveyed with the aid of the rotation of the screw 5, within the interior 11a, along a conveying zone which is shown diagrammatically in FIG. 1 through the use of arrows 15, in the direction of a region 13 and at the same time mixed with a physical blowing agent. The mixing of plastics melt and blowing agent is concluded in the region 13. The opening of a closable orifice 14, which is formed as a closure nozzle, then allows the mixture to be delivered.

A ball reflux barrier 20 with a melt entrance channel 6, a melt exit channel or section 12, a closure ball 3 in a chamber 3a for opening/closing the melt entrance channel 6 within the ball reflux barrier 20 and a limiting device or bolt 2 for preventing the ball 3 from closing the melt exit channel 12, is disposed in a section B before an exit orifice 21 of the screw bore 4 which forms at least part of a channel for the supply of the physical blowing agent.

FIG. 1 shows a situation before the start of an injection operation, in which plastics material molten and homogenized through the use of rotation of the screw 5 is conveyed from section A in the direction of section B. When this melt reaches the end of the screw 5, it passes through the melt entrance channel 6. As it does so, the melt cannot flow through a gap 16 between the ball reflux barrier 20 and the cylinder wall 11, since the circumference of the ball reflux barrier 20 in the region between the melt entrance channel 6 and the melt exit channel 12 is constructed so as to be sufficiently narrow.

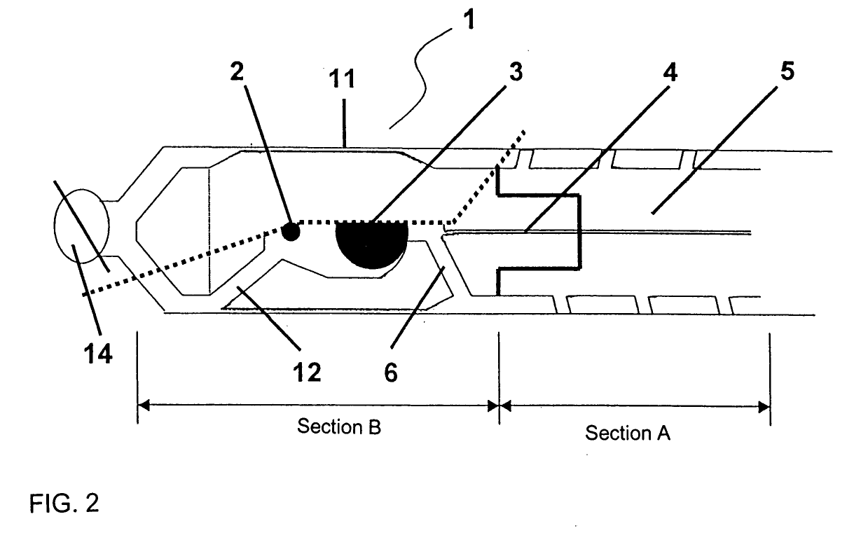

By virtue of the conveying action of the screw 5 in the course of metering of the melt into the region 13, the ball 3 in the chamber 3a slides against the bolt 2, which provides an orifice (compare FIGS. 1 and 2) between the melt entrance channel 6 and the melt exit channel 12. As a result of the movement of the ball 3, the central screw bore 4 is simultaneously uncovered and the physical blowing agent present therein can flow through the exit orifice 21 into the melt. The ball reflux barrier 20 is screwed onto the screw 5, so that a screw connection 22 is formed. There may also be provision for the ball reflux barrier 20 to be a one-piece structure with the screw 5. The exit of the physical blowing agent from the exit orifice 21 into the plastics melt is controlled with the aid of the ball reflux barrier 20. However, the blowing agent supply through the central screw bore 4 into the melt only occurs when the pressure of the blowing agent is higher than the melt pressure prevailing in the plasticizing unit 1.

A sealing casing for the supply of the physical blowing agent from a non-illustrated blowing agent source must be provided between the screw 5 and the screw cylinder 11 on the drive side of the apparatus according to FIG. 1. The non-illustrated sealing casing rotates simultaneously with the axial movement of the screw 5. The entire system is thus constructed as a rotational seal. One or more non-illustrated radial bores connect the blowing agent source to the central screw bore 4.

Mixing occurs between melt and blowing agent in conjunction with the flowing melt as a result of the rotational movement of the screw 5 and of the ball reflux barrier 20 which follows. The melt which then contains blowing agent leaves the ball reflux barrier 20 and collects in the region 13. The closable orifice 14, constructed as a closure nozzle, at the end of the plasticizing unit 1, ensures that the blowing agent-containing melt cannot exit prematurely during the metering operation of the screw 5.

FIG. 2 shows the plasticizing unit 1 according to FIG. 1 during the injection operation. The closure nozzle 14 is opened for the injection operation, as a result of which the blowing agent-containing melt of the plastic, which was stored in the region 13, is injected into a non-illustrated injection mold by a forward movement of the screw 5.

Due to the forward movement of the screw 5 in the course of delivery of the plastics melt through the closable orifice 14, the ball 3 is forced backward and, as a result thereof, against the flow entrance channel 6 and in the direction of the exit orifice 21 of the axial screw bore 4 of the screw 5. Blowing agent-containing melt of the plastic from the region 13 thus flows exclusively through the closable orifice 14 formed as a closure nozzle, out of the interior 11a and not back through the flow entrance channel 6. In this way, the reflux barrier 20 controls not only the exit of the physical blowing agent from the exit orifice 21 but also the flow of the plastics melt in the interior 11a.

As is evident from FIG. 2, the movement of the ball 3 in the direction of the exit orifice 21 of the axial screw bore 4 could allow melt which is present within the ball reflux barrier 20 to enter the central screw bore 4 of the screw 5. However, this amount of melt can be reduced or eliminated by a suitable selection of the diameter of the central screw bore 4 of the screw 5. The period for which melt can pass through the exit orifice of the axial screw bore 4 in the course of the injection operation is determined in this case substantially by the separation of the ball 3, which still adjoins the metal bolt 2 just before the injection operation, and the exit orifice of the central bore 4. After the injection operation, the pressure with which the blowing agent is introduced into the melt must be smaller than the melt pressure, so that the blowing agent cannot flow in the direction of material feed.

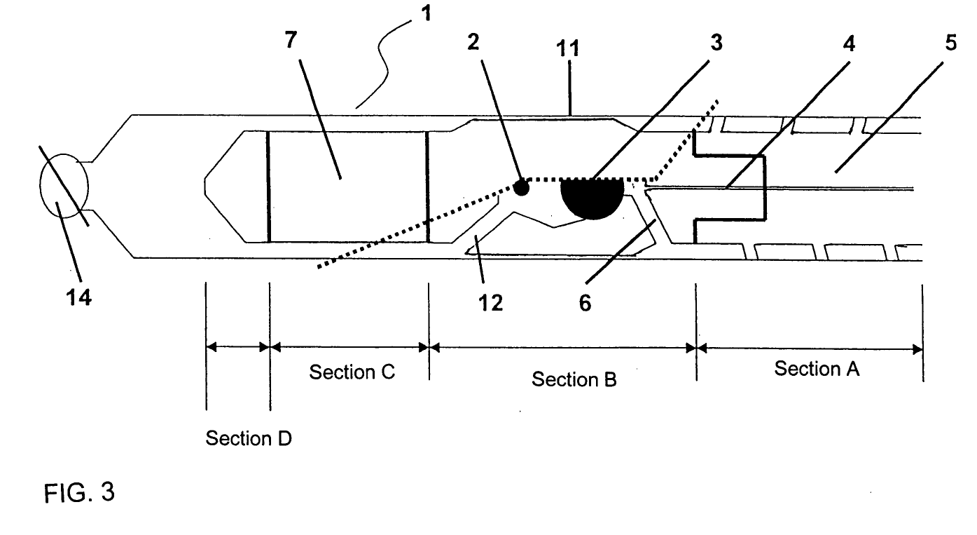

FIG. 3 shows a further apparatus for plasticizing a plastic with a physical blowing agent, in which the blowing agent-containing melt, in the course of metering of polymer material, after passing through the melt exit orifice 12, is conducted through an additional mixing element 7 which is connected to the ball reflux barrier 20. The mixing of the blowing agent with the melt is intensified as a result of the additional mixing element 7 which may, for example, be a smooth shaft or a so-called “Twente” mixing element.

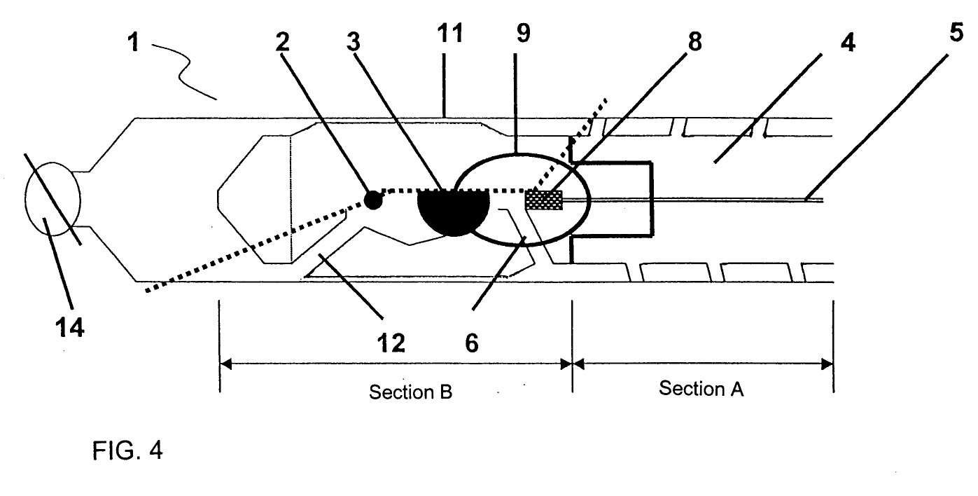

FIG. 4 shows another apparatus for plasticizing a plastic with a physical blowing agent, which is similar to the apparatus shown in FIG. 1. In order to prevent the penetration of melt into the central screw bore or channel 4, a sintered metal 8 is present, having pores which are selected in such a way that the physical blowing agent exits from the axial screw bore 4 through the sintered metal 8, but melt cannot enter.

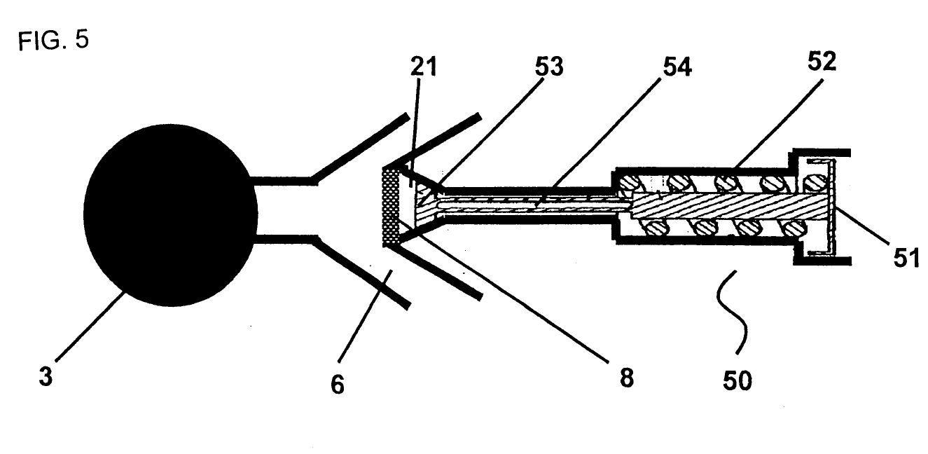

Instead of a sintered metal, according to FIG. 5, a spring-controlled valve 50 can also be provided, which is opened by the supply pressure of the physical blowing agent. The valve 50 is opened to release the physical blowing agent by virtue of application of a pressure built up by the blowing agent to an end part 51, so that a valve tappet 53 coupled to the end part 51 through a coupling component 54 is moved against the force of a spring 52 in the direction of the sintered metal 8. As a result of this, the channel exit orifice 21 is uncovered partly, and blowing agent can exit through the sintered metal 8. In addition to the combination of sintered metal 8 and spring-controlled valve 50 shown in FIG. 5, the latter can also be employed without the sintered metal 8.

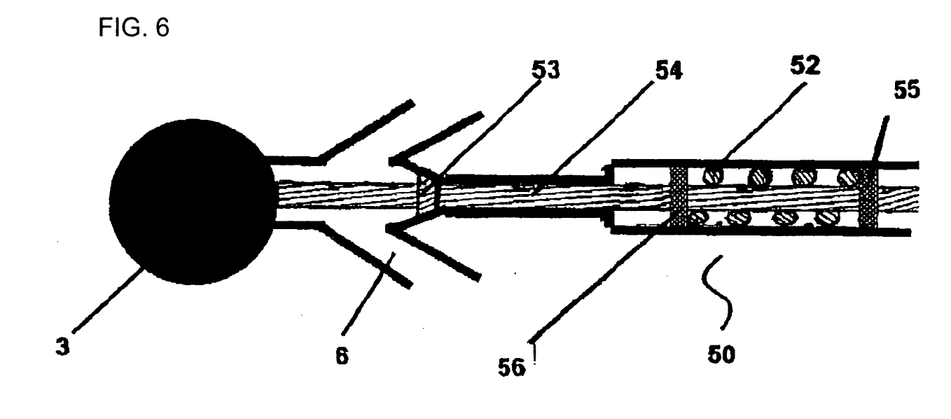

FIG. 6 shows a diagrammatic illustration of the section of the channel for supplying a blowing agent according to FIG. 5 in the course of the injection operation, in which the spring-controlled valve 50 is modified as compared to the embodiment shown in FIG. 5. The valve tappet 53 is formed in such a way that it is fixed to the coupling component 54, or even constructed in one piece therewith. The coupling component 54 in turn is extended up to the ball 3. A component 56 which encompasses the coupling component 54 and is connected thereto in a fixed manner is constructed from a porous material or in such a way that the blowing agent can flow past its periphery. With the aid of the component 56, the spring 52 is stressed/destressed, and adjoins, on the opposite side, a further component 55 which is made of a material permeable to the blowing agent, for example a porous material, and has a bore within which the coupling component 54 shifts when the ball 3 moves. In the stressed state of the spring, the valve tappet 53 closes the blowing agent feed.

In the course of the non-illustrated metering operation, the ball 3 moves to the left in FIG. 6, in the direction of the bolt 2 (which is not shown in FIG. 6, but is seen in FIGS. 1-4), so that the spring 52 is unstressed, and the valve tappet 53 is also moved to the left due to the associated movement of the coupling component 54, which then uncovers the feed of the physical blowing agent.

The features of the invention disclosed in the above description, the claims and the drawing may be of significance both individually and in any combination for the implementation of the invention in its different embodiments.

I claim:

1. An apparatus for producing and delivering a foamable plastic containing a physical blowing agent, the apparatus comprising:
a casing having a closable orifice and an interior with at least one subsection and a conveying zone;
a screw disposed in said interior for conveying a stream of a plastics melt through said at least one subsection along said conveying zone to said closable orifice;
said screw having a channel with a channel exit orifice in a vicinity of said conveying zone for supplying the physical blowing agent to be added to the plastics melt; and
a control unit disposed at said screw outside said channel in front of said channel exit orifice, for controlling exiting of the physical blowing agent from said channel.

2. The apparatus according to claim 1, wherein said closable orifice supplies the plastics melt for injecting a foamable plastic.

3. The apparatus according to claim 1, wherein said conveying zone for the plastics melt has a section formed through said control unit.

4. The apparatus according to claim 1, wherein said control unit is a flow control unit for controlling a flow of the plastics melt along said conveying zone.

5. The apparatus according to claim 4, wherein said flow control unit conducts a reflux barrier for said stream of plastics melt along said conveying zone.

6. The apparatus according to claim 5, wherein said flow control unit is a ball reflux barrier with a ball component disposed to be mobile within a chamber, for controlling said exiting of the physical blowing agent from said channel and said stream of the plastics melt.

7. The apparatus according to claim 6, which further comprises an exit section for the plastics melt, and a limiting device for limiting movement of said ball component within said chamber to prevent blockage of said exit section by said ball component.

8. The apparatus according to claim 1, which further comprises a screw connection securing said control unit on said screw.

9. The apparatus according to claim 1, wherein said channel exit orifice is formed at an end of said screw.

10. The apparatus according to claim 1, which further comprises a mixing element disposed downstream of said control unit in conveying direction of the plastics melt in said interior, for mixing plastics melt and physical blowing agent.

11. The apparatus according to claim 1, which further comprises a protective device disposed at said channel exit orifice for blocking entry of the plastics melt through said channel exit orifice into said channel.

12. The apparatus according to claim 11, wherein said protective device forms a cover for said channel exit orifice from a material having pores permeable to the physical blowing agent but blocking entry of the plastics melt through said channel exit orifice into said channel.

13. The apparatus according to claim 12, wherein said material is a sintered metal.

14. The apparatus according to claim 11, wherein said protective device includes a spring-controlled valve to be opened by a pressure built up by the physical blowing agent in said channel to release the physical blowing agent through said channel exit orifice against a spring force.

15. A process for producing and delivering a foamable plastic containing a physical blowing agent, the process comprising the following steps:
providing an apparatus including a casing having a closable orifice and an interior with at least one subsection, a conveying zone and a screw;
conveying a stream of a plastics melt through the at least one subsection along the conveying zone toward the closable orifice;
adding the physical blowing agent to the plastics melt by feeding the physical blowing agent to a region of the conveying zone through a channel formed in the screw and an exit orifice of the channel;
mixing the plastics melt and the physical blowing agent along the conveying zone;
delivering the plastics melt mixed with the physical blowing agent through the closable orifice of the casing; and
controlling exiting of the physical blowing agent from the channel through the channel exit orifice with a control unit disposed at the screw, outside the channel and in front of the channel exit orifice.

16. The process according to claim 15, which further comprises supplying the plastics melt from the closable orifice for injecting a foamable plastic.

17. The process according to claim 15, which further comprises conducting the stream of the plastics melt along a section through the control unit.

18. The process according to claim 15, wherein the control unit is a flow control unit controlling the exiting of the physical blowing agent through the channel exit orifice and flow of the plastics melt.

19. The process according to claim 18, which further comprises blocking reflux of the stream of the plastics melt with the flow control unit.

20. The process according to claim 19, wherein the flow control unit is a ball reflux barrier with a ball component disposed to be mobile within a chamber, for controlling the exiting of the physical blowing agent from the channel and the stream of the plastics melt.

21. The process according to claim 20, which further comprises limiting movement of the ball component within the chamber with a limiting device for preventing blockage of an exit section for the plastics melt, by the ball component.

22. The process according to claim 15, which further comprises adding the physical blowing agent through the channel exit orifice at an end of the screw.

23. The process according to claim 15, which further comprises mixing the plastics melt and the physical blowing agent with a mixing element disposed downstream of the control unit in conveying direction of the plastics melt in the interior.

24. The process according to claim 15, which further comprises blocking entry of the plastics melt through the channel exit orifice into the channel with a protective device at the channel exit orifice.

25. The process according to claim 24, which further comprises forming a cover for the channel exit orifice with the protective device from a material having pores permeable to the physical blowing agent but blocking the entry of the plastics melt through the channel exit orifice into the channel.

26. The process according to claim 25, wherein the material is a sintered metal.

27. The process according to claim 24, which further comprises opening a spring-controlled valve by a pressure built up by the physical blowing agent in the channel to release the physical blowing agent through the channel exit orifice against a spring force.
